(19) United States
(12) Patent Application Publication
(10) Pub. No.: US 2017/0371970 A1
(43) Pub. Date: Dec. 28, 2017

(54) AUTOMATED STORYLINE CONTENT SELECTION AND QUALITATIVE LINKING BASED ON CONTEXT

(71) Applicant: International Business Machines Corporation, Armonk, NY (US)

(72) Inventors: Harish Bharti, Pune (IN); Sanjib Choudhury, Pune (IN); Kshitij K. Raval, Pune (IN); Rajesh K. Saxena, Pune (IN)

(21) Appl. No.: 15/194,736

(22) Filed: Jun. 28, 2016

(51) Int. Cl. G06F 17/30

(52) U.S. Cl. CPC G06F 17/30882; G06F 17/3097; G06F 17/3087; G06F 17/30958

(57) ABSTRACT

A huge volume of unstructured content is available on the internet. Social media websites, news outlets, subject matter expert sites, forums, government organization sites, non-government organization sites, etc., collectively provide a rich source of raw material for any kind of story writing, for example, for movies, novels, television, etc. In some embodiments of the present invention, content is intelligently searched from diverse sources. Embodiments of the present invention make use of such unstructured content, to provide raw material upon which to base a cohesive and appealing story, in part by applying graphing theory to: (i) represent content gathered in the search as a graph, with each element of content assigned to a node of the graph; (ii) qualitatively link the nodes; and/or (iii) identify important nodes which potentially become central to a storyline.

### BACKGROUND

The present invention relates generally to the field of automated story composition, and more particularly to organization and selection of network addressable raw content available for re-use in stories composed (in whole or in part) by machine logic (that is, machine logic in the form of computer hardware and/or software).

Traditionally, stories have been written by human authors. As is known, these stories may be long or short, fiction or non-fiction, etc. Stories generally have emotional aspects including: (i) emotions of the characters in the stories; and/or (ii) emotions expected to be evoked in readers of the story. Stories written by human beings typically have some degree of time continuity, continuity of characters, subject matter continuity, continuity of culture, continuity of language (for example, English, French), continuity of reading level, continuity of tone and continuity of geography.

More recently, some stories have come to be composed by machine logic. It is known to use network addressable content (for example, text, pictures audio and/or video available on internet websites) as an input for machine logic based story creation. More specifically, this “raw content” is downloaded, selectively used (and selectively discarded), and modified and combined by machine logic rules to form a story. Generally, the goal is to create a story that sounds like it could have been created by human author(s).

There is a large amount of unstructured content (that is, raw content) available on the internet, including, but not limited to, social media websites. Some conventional systems automatically generate stories, including for example, news stories in the field of sports reporting, based in part on large sources of structured data, including statistics and the like. Automated story-writing systems are implemented, or in development, in other fields, such as finance, real estate and other data-intensive fields.

### SUMMARY

According to an aspect of the present invention, there is a method for creating an automated story that performs the following operations (not necessarily in the following order): (i) receiving a plurality of content data sets with each content data set including network addressable content useful in creating narrative content for the automated story; (ii) creating a story data graph data structure stored in a graph database, with the creation of the graph data structure including defining a plurality of nodes, with each node of the plurality of nodes respectively corresponding to a content data set of the plurality of content data sets, and with each node including the content data of the respectively corresponding content data set and the contextual metadata of the respectively corresponding to attributes of a context of the corresponding context data set, and defining a plurality of connections among and between the nodes based upon the contextual metadata of the nodes; (iii) for each given node of the plurality of nodes, determining an aggregate connectedness value based upon the connections in which the given node is involved; (iv) identifying, by a processor set, a subset of recommended candidate nodes of the plurality of nodes based, at least in part, upon the aggregate connectedness values of the nodes of the plurality of nodes; and (v) recommending the recommended candidate nodes of the subset of recommended candidate nodes for use in the automated story.

According to a further aspect of the present invention, there is a computer program product for creating an automated story that performs the following operations (not necessarily in the following order): (i) receiving a plurality of content data sets with each content data set including network addressable content useful in creating narrative content for the automated story; (ii) creating a story data graph data structure stored in a graph database, with the creation of the graph data structure including defining a plurality of nodes, with each node of the plurality of nodes respectively corresponding to a content data set of the plurality of content data sets, and with each node including the content data of the respectively corresponding content data set and the contextual metadata of the respectively corresponding to attributes of a context of the corresponding context data set, and defining a plurality of connections among and between the nodes based upon the contextual metadata of the nodes; (iii) for each given node of the plurality of nodes, determining an aggregate connectedness value based upon the connections in which the given node is involved; (iv) identifying, by a processor set, a subset of recommended candidate nodes of the plurality of nodes based, at least in part, upon the aggregate connectedness values of the nodes of the plurality of nodes; and (v) recommending the recommended candidate nodes of the subset of recommended candidate nodes for use in the automated story.

According to a further aspect of the present invention, there is a system for creating an automated story that performs the following operations (not necessarily in the following order): (i) receiving a plurality of content data sets with each content data set including network addressable content useful in creating narrative content for the automated story; (ii) creating a story data graph data structure stored in a graph database, with the creation of the graph data structure including defining a plurality of nodes, with each node of the plurality of nodes respectively corresponding to a content data set of the plurality of content data sets, and with each node including the content data of the respectively corresponding content data set and the contextual metadata of the respectively corresponding to attributes of a context of the corresponding context data set, and defining a plurality of connections among and between the nodes based upon the contextual metadata of the nodes; (iii) for each given node of the plurality of nodes, determining an aggregate connectedness value based upon the connections in which the given node is involved; (iv) identifying, by a processor set, a subset of recommended candidate nodes of the plurality of nodes based, at least in part, upon the aggregate connectedness values of the nodes of the plurality of nodes; and (v) recommending the recommended candidate nodes of the subset of recommended candidate nodes for use in the automated story.

According to a further aspect of the present invention, there is a method that performs the following operations (not necessarily in the following order): (i) receiving a graph data structure stored in a graph database, with the graph data structure including a plurality of nodes, and a plurality of connections; and (ii) for each node of the plurality of nodes, applying, by a processor set, connectivity parity to identify a subset of recommended candidate nodes, with the recommended candidate nodes corresponding to content data sets recommended for use in creating a narrative story.

According to a further aspect of the present invention, there is a computer program product that performs the following operations (not necessarily in the following order): (i) receiving a graph data structure stored in a graph database, with the graph data structure including a plurality of nodes, and a plurality of connections; and (ii) for each node of the plurality of nodes, applying, by a processor set, connectivity parity to identify a subset of recommended candidate nodes, with the recommended candidate nodes corresponding to content data sets recommended for use in creating a narrative story.

According to a further aspect of the present invention, there is a system that performs the following operations (not necessarily in the following order): (i) receiving a graph data structure stored in a graph database, with the graph data structure including a plurality of nodes, and a plurality of connections; and (ii) for each node of the plurality of nodes, applying, by a processor set, connectivity parity to identify a subset of recommended candidate nodes, with the recommended candidate nodes corresponding to content data sets recommended for use in creating a narrative story.

### BRIEF DESCRIPTION OF THE DRAWINGS

FIG. 1A is a block diagram of a first embodiment of a system according to the present invention;

FIG. 1B is a block diagram of a portion of the first embodiment system;

FIG. 2 is a flowchart showing a first embodiment of a method performed, at least in part, by the first embodiment system;

FIG. 3 is a block diagram showing a machine logic (for example, software) portion of the first embodiment system;

FIG. 4A is a block diagram showing a first view of a story data graph used by the first embodiment system in performing the first embodiment method;

FIG. 4B is a block diagram showing a second view of a story data graph used by the first embodiment system in performing the first embodiment method;

FIG. 4C is a block diagram showing a third view of a story data graph used by the first embodiment system in performing the first embodiment method;

FIG. 4D is a block diagram showing a fourth view of a story data graph used by the first embodiment system in performing the first embodiment method;

FIG. 4E is a block diagram showing a fifth view of a story data graph used by the first embodiment system in performing the first embodiment method;

FIG. 5 is a block diagram showing various stages of an automated story creation process; and

FIG. 6 of a graph for use in connection with a second embodiment of a method according to the present invention.

### DETAILED DESCRIPTION

A huge volume of unstructured content is available on the internet. Social media websites, news outlets, subject matter expert sites, forums, government organization sites, non-government organization sites, etc., collectively provide a rich source of raw material for any kind of story writing, for example, for movies, novels, television, etc. In some embodiments of the present invention, content is intelligently searched from diverse sources. Embodiments of the present invention make use of such unstructured content, to provide raw material upon which to base a cohesive and appealing story, in part by applying graphing theory to: (i) represent content gathered in the search as a graph, with each element of content assigned to a node of the graph; (ii) qualitatively link the nodes; and/or (iii) identify important nodes which potentially become central to a storyline. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

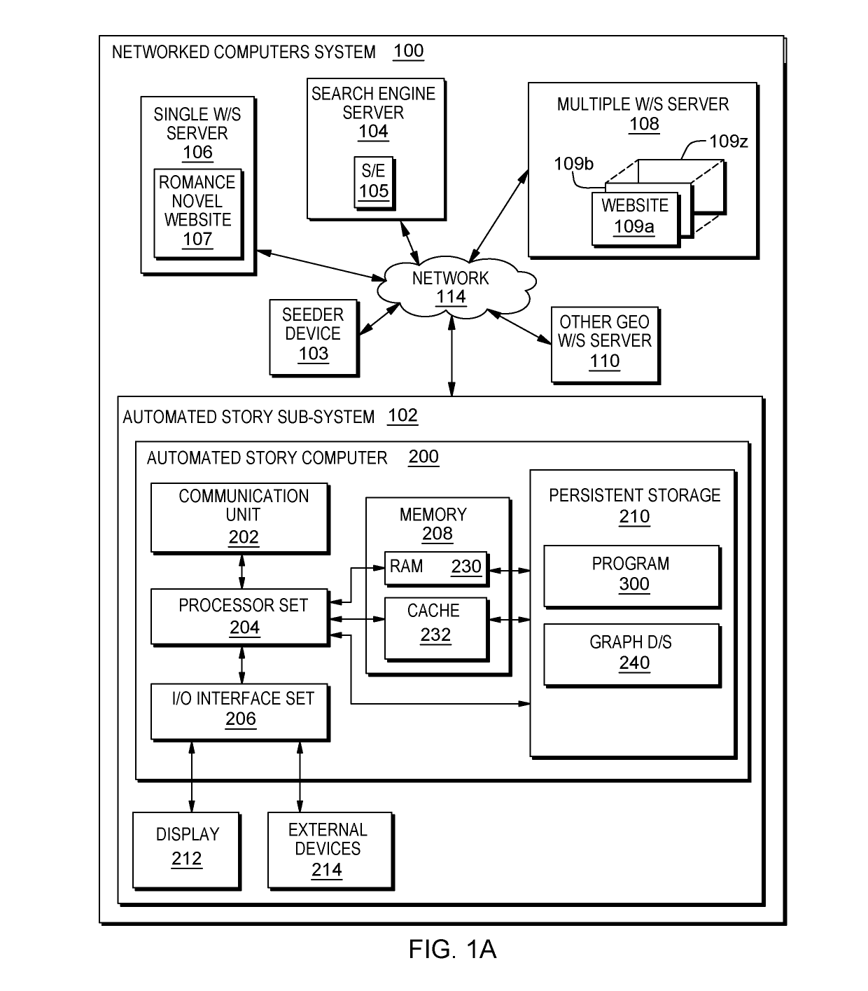

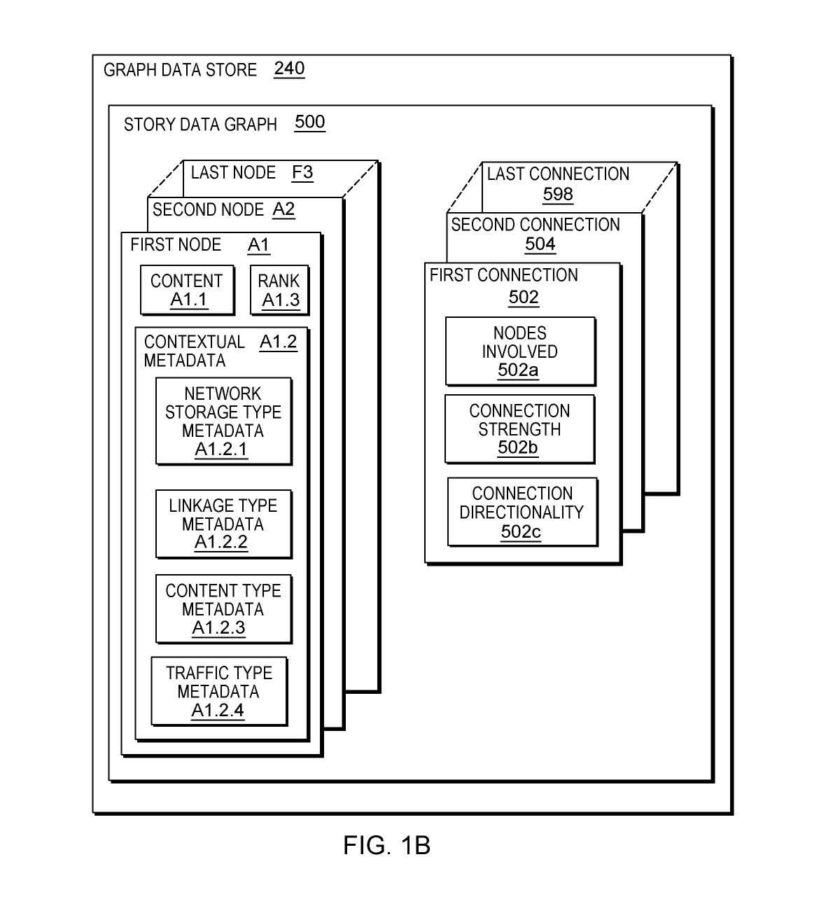

An embodiment of a possible hardware and software environment for software and/or methods according to the present invention will now be described in detail with reference to the Figures. FIGS. 1A and 1B are, collectively, a functional block diagram illustrating various portions of networked computers system 100, including: automated story sub-system 102; seeder device 103; search engine server 104; search engine 105; single website server 106; romance novel website data set 107; multiple website server 108; website data sets 109a to 109z; other geo website server 110; network 114; automated story computer 200; communication unit 202; processor set 204; input/output (I/O) interface set 206; volatile memory 208; persistent storage 210; display device 212; external device set 214; random access memory (RAM) 230; cache 232; graph data store 240; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage.

Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

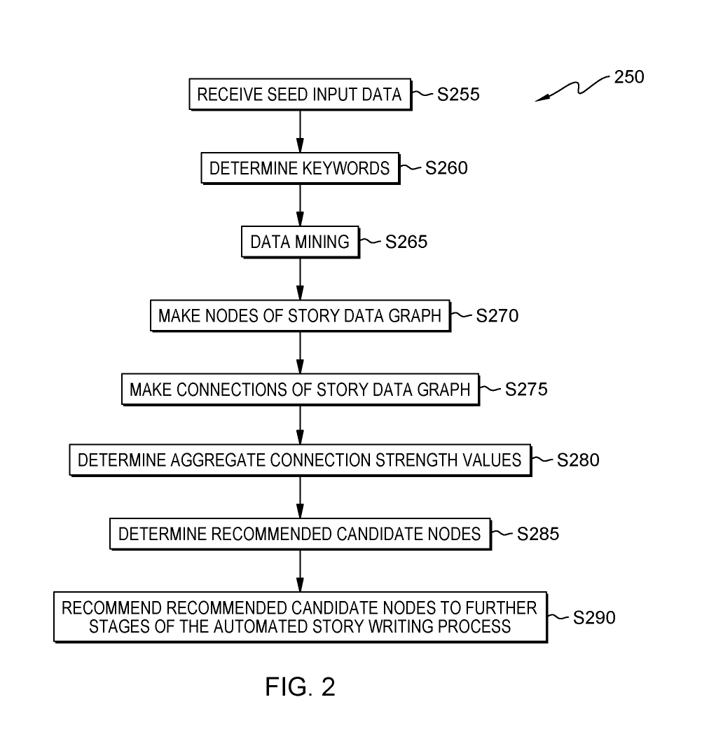

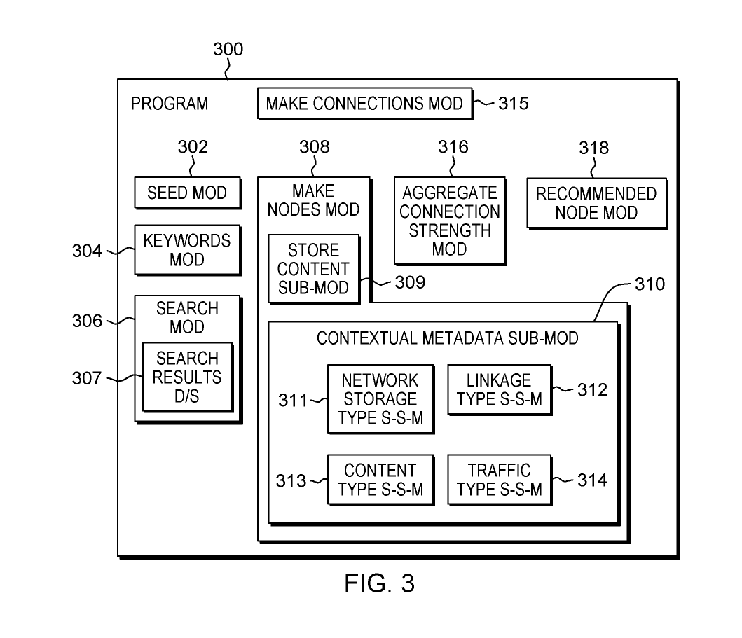

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where seed module (“mod”) 302 story receives seed input data from seeder device 103 (for example, a word processing program running on a laptop computer) through communication network 114 (see FIG. 1A). In this embodiment, a human user supplies the story seed input data. Alternatively, the story seed input data could be supplied by machine logic. Generally speaking, the story seed input data includes information indicative, or descriptive, of how the automated story should turn out, but, of course, the story seed input data will be less elaborate and detailed than the finished story to be composed, in an automated fashion with substantially no human intervention (see definition, below, of “without substantial human intervention”) by program 300. More specifically, story seed input data may include one or more of the following types of seed information: topic, genre, context, key words or phrases, theme, mood, setting, time, place, emotional content, general outline.

In this example of method 250, the story seed input data is as follows: “A romantic love story involving two people having two popular professions, where the love is threatened by a contemporary crisis, but the love between the two people is successful in the end. It is further desired that the story include some unusual subject matter juxtapositions so that it is regarded as a truly creative work, rather than as a hackneyed or trite story that is essentially duplicative of stories that have previously been drafted by humans and/or computers.” In this example, the story seed input data is in the form of a short narrative passage written in natural language (specifically, English language). Alternatively, this data could take the form of a set of records, with field values, in a structured database. As a further alternative any data set, structured or unstructured, human understandable or machine readable, could be used so long it has a sufficient quantity and quality of seed information to seed an automated story.

Processing proceeds to operation S260, where get keywords mod 304 determines keywords to be used in data mining based on the story seed input data based on machine logic based rules. Alternatively, a human user could determine the keywords. Note, the “keywords” may be in the form of phrases. In this example, the keywords are determined to be as follows: (i) romance; (ii) love; (iii) popular professions; (iv) contemporary crisis; (v) problems caused by the contemporary crisis; and (vi) successful love. In this example, many of the keywords are pulled directly from the story seed input data. However, “problems caused by the contemporary crisis” is a keyword that is based on “understanding” of the story seed input data by mod 304. Specifically, it had to be understood that crises tend to cause a thing called “problems” and that it is these “problems” that tend to affect everyday lives of individual people.

Processing proceeds to operation S265, where search mod 306, working in conjunction with search engine 105 of search engine server 104 (see FIG. 1A), conducts an automated search (also sometimes herein referred to as “data mining”) based on the keywords obtained at operation S260. The search is conducted by search engine software (see FIG. 1A at search engine 105 of search engine server 104), which searches internet sources including, social media web sites, news web sites, web logs, video logs, commercial enterprise web sites, government web sites, etc. In addition internet accessible sources, other network addressable locations (for example, private data collections) may be searched if proper authorization has been obtained.

In this example, the searches based on the keywords are as follows: (i) romance (ii) love; (iii) “popular professions” (as a phrase); (iv) “contemporary crisis” (as a phrase); (v) “problems caused by [variable string];” and (vi) “successful love” (as a phrase). Most of these searches match the keywords, previously obtained at operation S260. However, search (v) uses a more sophisticated technique where a “variable” is filled in using words (or phrases) obtained from results of performing search (iv). This demonstrates the larger point that data mining may sometimes involve more than simply plugging keywords into a search engine.

Staying with the current example of performing operation S265, the searches, as set forth in the previous paragraph, return the search results in the form of network accessible resources (which, in this example, are all publically available websites identified by uniform resource locator addresses (“URLs”)). The search results from searches (i) to (vi) will be respectively discussed in the next six (6) paragraphs.

Search (i) (that is “romance”) yields the following network addressable “content data sets” (for example, text, images, audio and/or video present at a website): (A1) from an online encyclopedia type website, a definition “a pleasurable feeling deriving from emotional attraction”; (A2) from a news type website, a news article that claims that romance involves mutual interests; and (A3) from a web site focused on novels of the “romance” genre, a list of some romance type novels and literary reviews thereof. Network addressable content data sets (A1) and (A2) were found at multiple website server 108 (see FIG. 1A). Content data set (A3) was found at romance novel website 107 of single website server 106.

Search (ii) (that is “love”) yields the following network addressable “content data sets”: (B1) from an online dictionary, a definition “feelings, states, attitudes that range from interpersonal affection to pleasure; (B2) from a song lyrics type web site, the lyrics to a popular “oldies” song called “Love Is A Much Enamored Thing”; and (B3) from an online sports magazine, an article titled “Tennis player gets zero points” (the article including occurrences of the word “love” in the vernacular of scoring tennis games).

Search (iii) (that is “popular professions”) yields the following network addressable “content data sets”: (C1) from a web site purporting to provide “the best answer to any question”, an article stating that the profession of “doctor” is the least popular profession; (C2) a document outlining attributes and requirements for the position of “zoo keeper”; and (C3) from a web site devoted to matching job seekers with employers, a listing of jobs in the field of “data analysis”.

Search (iv) (that is “contemporary crisis”) yields the following network addressable “content data sets”: (D1) from a news web site, an article describing an elevated level of lead in a certain city's drinking water supply; (D2) an online encyclopedia-type website describing aspects of Ebola Virus Disease; and (D3) from an online news website, an article focusing on a plan to improve primary school math education.

Search (v) (that is “problems caused by [variable string]”) yields the following network addressable “content data sets”: (E1) (variable string “lead in drinking water”) from a general news web site, an article describing health problems potentially causes by lead in drinking water; (E2) (variable string “Ebola virus”) from a scientific journal, an article questioning whether health-related travel restrictions and travel bans can be an effective method of for containing an outbreak of Ebola infections; and (E3) (variable string “children not learning enough math and science”) from a business news type web site, an article describing a correlation between math/science education in various nations and gross domestic product statistics for those nations.

Search (vi) (that is “successful love”) yields the following network addressable “content data sets”: (F1) non-fiction popular advice type article written by a psychologist and titled “Commitment”; (F2) from a relationship advice type column, an article titled “Conflicts Settled Quickly”; and (F3) from a first-person (presumably non-fiction) account of successful love, which describes successful love as leading to “indescribable happiness.”

The search results obtained at operation S265 include: (i) content (sometimes herein referred to as articles, or resources) which is the actual data, such as the content of a web page including text, images, etc.; and/or (ii) content data set metadata (sometimes also referred to herein as website metadata), which should not be confused with “contextual metadata” (which will be discussed later on when the search results data is being organized into a graph data structure). These search results are temporarily stored at search results data store 307 of mod 306.

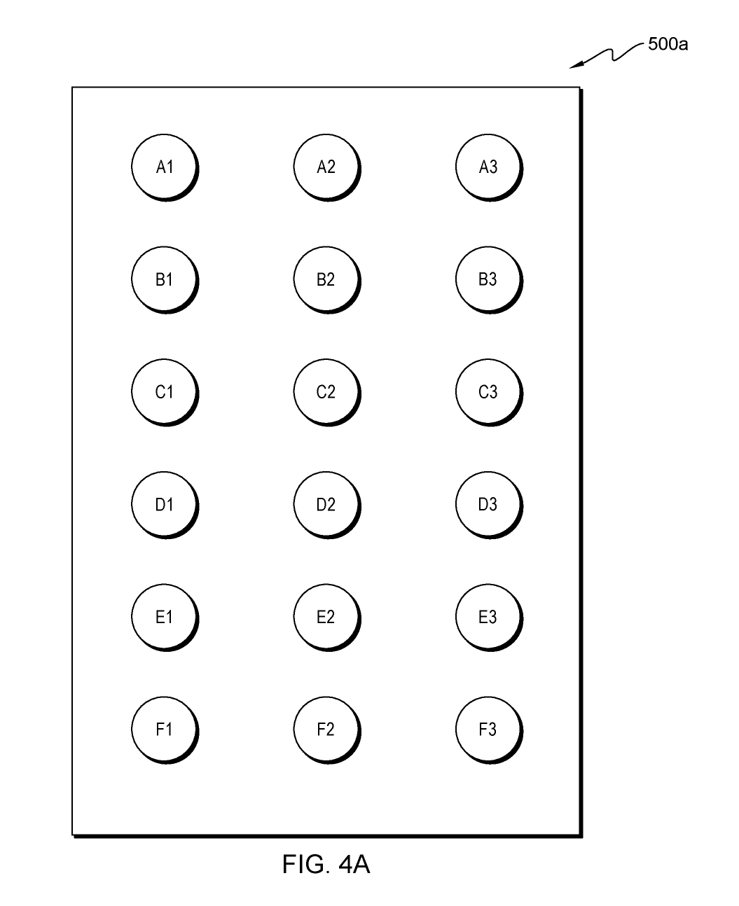

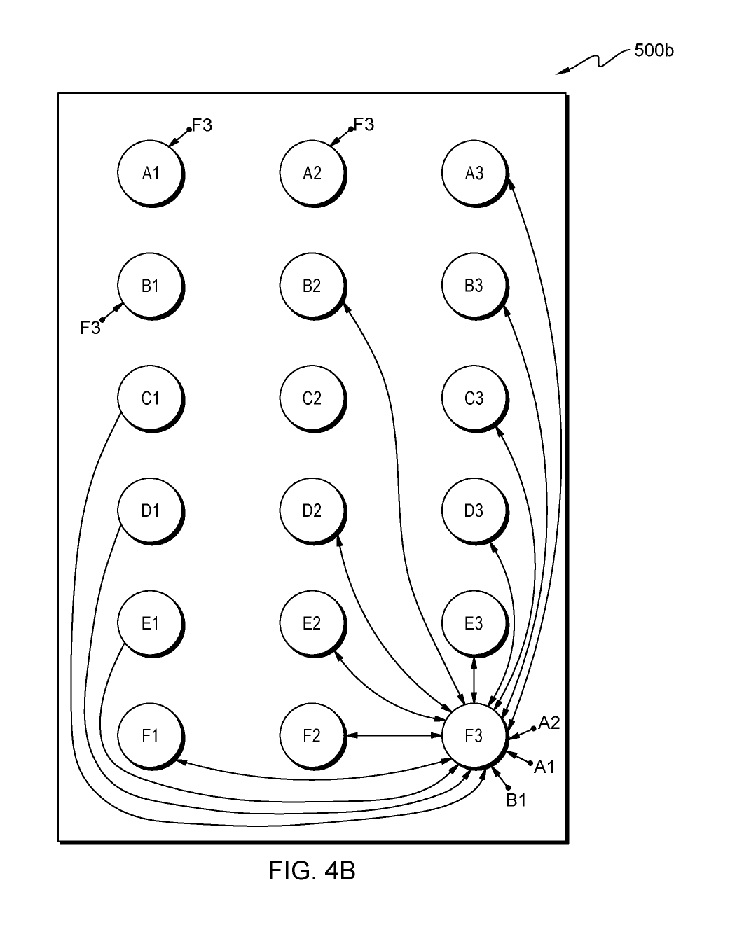

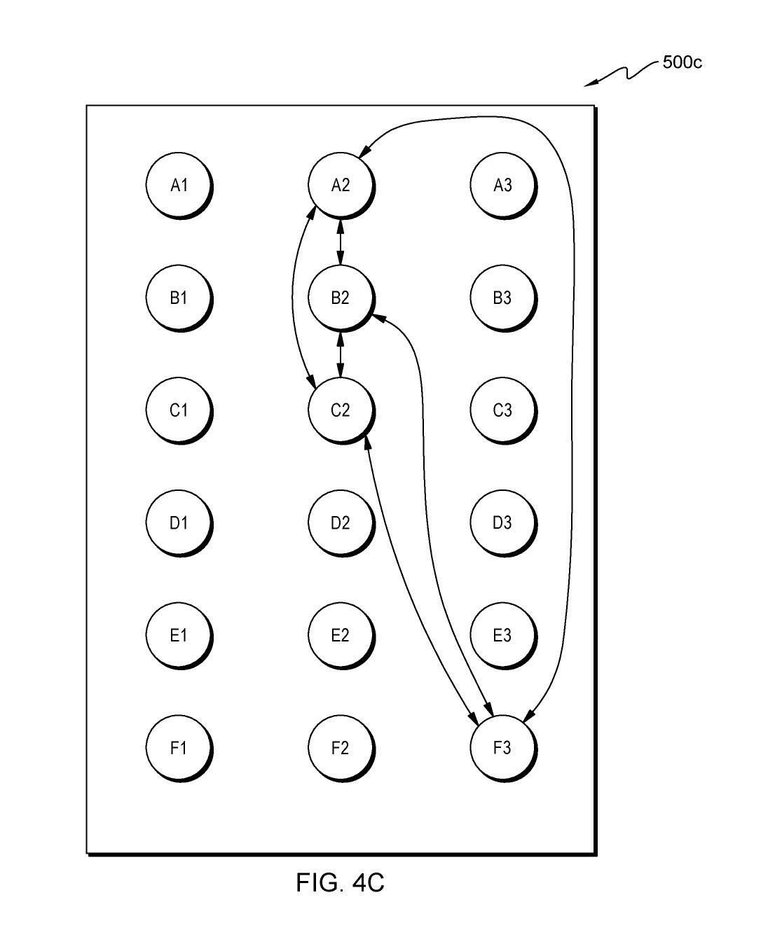

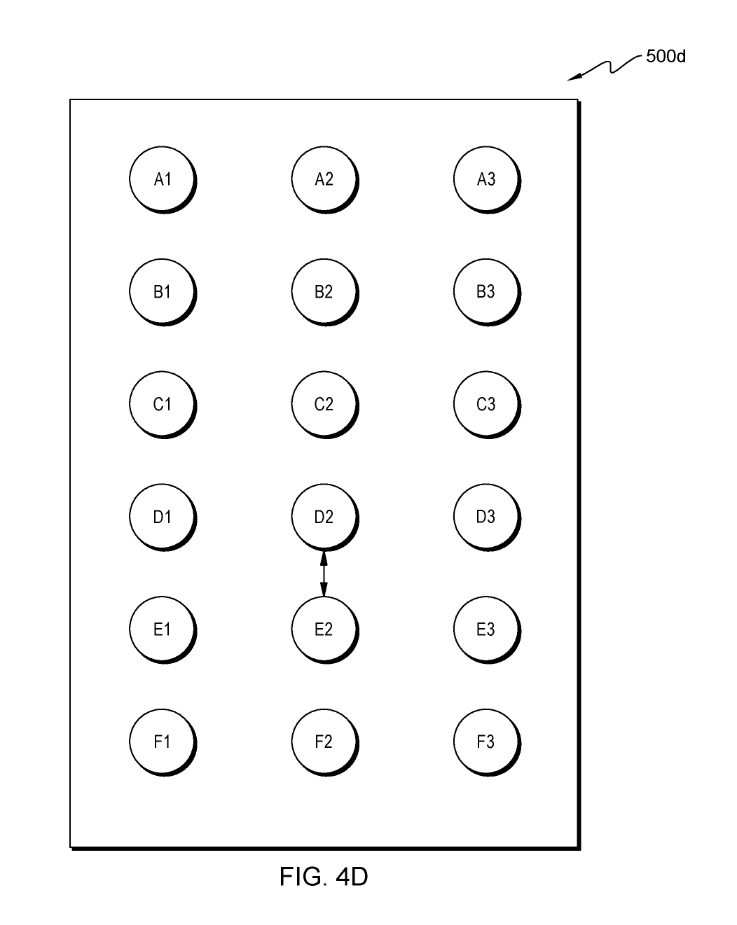

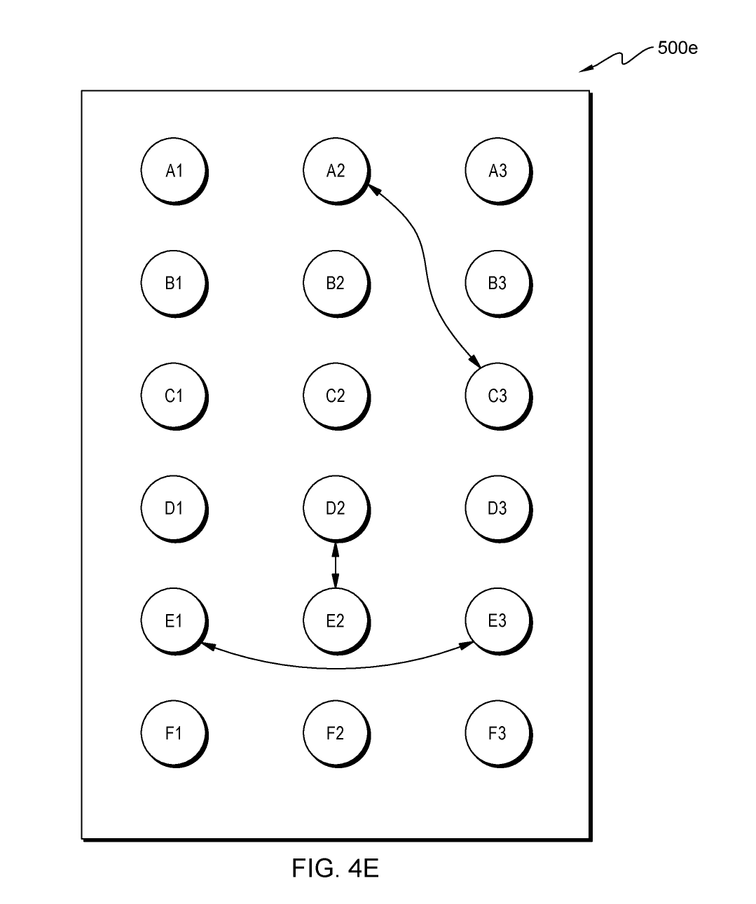

Processing proceeds to operation S270, where construction of a story data graph data structure (also referred to, more simply, as a story data graph) begins using the search results obtained at operation S265. More specifically, at operation S270, make nodes mod 308 stores each search result as a respective node data structure of the story data graph 500, as shown in the Figures at: (i) FIG. 1B at nodes A1 to F3 of story data graph 500 stored in graph data store 240; and (ii) FIG. 4A at nodes A1 to F3 of story data graph 500a (that is story data graph 500 at point in time “a” before any connections have been made). Even more specifically, at operation S270: (i) store content sub-mod 309, of make nodes mod 308, stores content (that is, data corresponding to human understandable text, images, audio and/or video) of the content data sets respectively corresponding to nodes A1 to F3 (see, FIG. 1B at content block for A1.1 and rank A1.3 in node A1); and (ii) “contextual metadata” begins to be stored for each node.

“Contextual metadata” will now be defined, followed by a discussion of how contextual metadata is used in the particular embodiment of method 250 and associated program 300 now under extended discussion. Contextual metadata is any data in (or associated with) a node in a story data graph that: (i) is not the content of the node; and (ii) relates to the content and/or the context of the network addressable data set from which the node is derived. Contextual metadata is used, as an input to machine logic rules (to be further discussed, below), to determine connections between the nodes of the story data graph so that preferred candidate nodes for use in an automated story can be determined. Various embodiments of the present invention may employ different types of contextual metadata, not necessarily limited to the types and sub-types of contextual metadata that will now be discussed in the following paragraphs.

In the embodiment of program 300, each node may have four different types of contextual metadata as follows: (i) network storage type contextual metadata, collected and stored by network storage type metadata sub-sub-module 311, of contextual data sub-mod 310, at a network storage metadata type portion of each node (see FIG. 1B at network storage type metadata block A1.2.1 of contextual metadata block A1.2 of first node A1 of story data graph 500); (ii) linkage type contextual metadata, collected and stored by linkage type contextual metadata sub-sub-module 312, of contextual data sub-mod 310, at a linkage type metadata portion of each node (see FIG. 1B at linkage type metadata block A1.2.2 of contextual metadata block A1.2 of first node A1 of story data graph 500); (iii) content type contextual metadata, collected and stored by content type contextual metadata sub-sub-module 313, of contextual data sub-mod 310, at a content type metadata portion of each node (see FIG. 1B at content type metadata block A1.2.3 of contextual metadata block A1.2 of first node A1 of story data graph 500); and (iv) traffic type contextual metadata, collected and stored by traffic type contextual metadata sub-sub-module 314, of contextual data sub-mod 310, at a traffic type metadata portion of each node (see FIG. 1B at traffic type metadata block A1.2.4 of contextual metadata block A1.2 of first node A1 of story data graph 500). These types of contextual metadata will be discussed in the following paragraphs.

NETWORK STORAGE TYPE: refers to contextual metadata relating to when, how, where and/or by whom the network addressable content data set, corresponding to a node, is stored in a network accessible manner. In this embodiment, the network storage type contextual metadata includes (when available) the following sub-types of network storage type contextual metadata: (i) identity of the owner of the network addressable storage location (for example, a website owner); (ii) location information (also called “geo”) about the location of the owner of the website; (iii) number of people employed by the owner of the website; (iv) identity of the party that registered the website; (v) location of the party that registered the website; (vi) location of the server(s) where the content data set is maintained in a network addressable fashion; (vii) date of original posting (that is, making the content data set available over the network); (viii) date of last edit to the content data set; and/or (ix) a uniform resource locator (URL) address of the network addressable content data set. Some of this information may be obtained from the content data set metadata (mentioned above). To the extent possible and/or available, in this embodiment, sub-sub-mod 311 collects the rest of this information automatically over the network(s) used to retrieve the content data sets using queries controlled by machine logic based rules in sub-sub-mod 311. In addition to network addressable content that the automated story computer collects through communications network(s), some embodiments may use content purchased and available locally on the automated story computer (for example, hundreds of articles, small scripts that a local user might have obtained (for example, from diskette publications) and saved locally on his computer or a local data storage such as archival storage in the external device set (see FIG. 1A)). However, some embodiments may handle these locally obtained content data sets differently than those obtained over a network because these locally obtained content data sets will often be missing some of the types of contextual metadata to be discussed below.

For example, in the embodiment under discussion, it will be recalled that node A3 corresponds to a website focused on novels of the “romance” genre, a list of some romance type novels and literary reviews thereof, which was found at romance novel website 107 of single website server 106 (see FIG. 1A). For this node, the network storage type contextual metadata is as follows: (i) identity of the owner of the network addressable storage location is Amanda Author (an individual); (ii) the location of the owner is: United States of America; (iii) number of people employed by the owner: one (1) (that is, Amanda Author, herself); (iv) identity of the party that registered the website is Acme Website Registrations Company; (v) location of Acme Website Registration Company is Mexico; (vi) location of the server(s) where the content data set is maintained in a network addressable fashion is not discoverable in this example, so this metadata field is left blank; (vii) date of original posting (that is, making the content data set available over the network) was 15 Jan. 2010; (viii) date of last edit to the content data set was 17 Jan. 2010; and (ix) a uniform resource locator (URL) address of the network addressable content data set is www.amandaauthor.com.

LINKAGE TYPE: refers to contextual metadata relating to network addressable data sets to which a given network addressable content data set (corresponding to a node) is linked (for example, linked by hyperlinks present in text type content. In this example, the linkage type contextual metadata includes the following sub-types of linkage type contextual metadata: (i) network addresses (for example URLs) to which the content of the node directly links (sometimes herein referred to as backlinks); (ii) network addresses that link directly to the network addressable data content set of the node (sometimes herein referred to as frontlinks); (iii) network addresses to which the content of a backlink site directly links (sometimes herein referred to as a second generation backlink); and/or (iv) network addresses that link directly to any frontlink (sometimes herein referred to as second generation frontlinks). Alternatively, more or fewer linkage sub-types can be included in the contextual metadata. For example, the linked sites may go beyond two generations. In some embodiments, linked websites may be considered for inclusion as nodes in the story data graph.

To the extent possible and/or available, in this embodiment, sub-sub-mod 312 collects this information from: (i) the content; and/or (ii) automatically over the network(s) used to retrieve the content data sets using queries controlled by machine logic based rules in sub-sub-mod 312.

CONTENT TYPE: refers to contextual metadata relating to: (A) features of the content itself; and/or (B) when, how, where and/or by whom the content data set, corresponding to a node, was written, generated or otherwise authored. In this embodiment, the content type contextual metadata includes (when available): (i) style of the content; (ii) theme of the content; (iii) plot elements of the content; (iv) visual features of the content (often quite relevant for content data sets include images and/or video); (v) features of characters, or actors, involved in the content; (vi) place(s) (sometimes called settings) where the content takes place (fictionally or in reality); (vii) place(s) where the content was authored (as distinct from where it was uploaded to a network storage location, place where the owner is located and/or place where the content is stored in a network addressable manner); (viii) time when the content was authored (as distinct from time of uploading); (ix) identity of content author(s); (x) place(s) where author(s) reside or are from; (xi) sophistication level (for example, “reading level” of content); (xii) events in lives of author(s) of the content (for example, schools where author(s) received education, occupation(s) held by author(s)); and/or (xiii) copyright information related to the content.

Some of this information may be obtained from the content data set metadata, itself (for example, derived from analytics as applied to the content). Some of this information may come from the content data set metadata (for example, copyright related data). To the extent possible and/or available, in this embodiment, sub-sub-mod 313 collects the rest of this information automatically over the network(s) used to retrieve the content data sets using queries controlled by machine logic based rules in sub-sub-mod 313.

For example, in the embodiment under discussion, it will be recalled that node (C2) corresponds to a content data set with content in the form of a document outlining attributes and requirements for the position of “zoo keeper.” For this node, sub-sub-mod 313 determines the content type contextual metadata to be as follows: (i) style of the content is “highly formal”; (ii) theme of the content is “man versus nature”; (iii) plot elements of the content are “hard work leads to success”; (iv) visual features of the content (often quite relevant for content data sets include images and/or video) are “cages, hay, feeding troughs and various types of animals”; (v) features of characters, or actors, involved in the content are “professional zookeeper who dabbles in general interest writing”; (vi) place(s) (sometimes called settings) where the content takes place (fictionally or in reality) is “the Cityville Zoo”; (vii) place(s) where the content was authored (as distinct from where it was uploaded to a network storage location, place where the owner is located and/or place where the content is stored in a network addressable manner) is “Great Britain”; (viii) time when the content was authored (as distinct from time of uploading) is 1880; (ix) identity of content author(s); (x) place(s) where author(s) reside or are from is “India (birthplace) and Great Britain (residence)”; (xi) sophistication level (for example, “reading level” of content) is “undergraduate college level”; (xii) events in lives of author(s) of the content (for example, schools where author(s) received education, occupation(s) held by author(s)) is “not available”; and/or (xiii) copyright information related to the content is “copyright 1899 by Cityville Newspaper, Inc. in Great Britain, Brazil and the United States of America”.

TRAFFIC TYPE: refers to contextual metadata relating to access operations made by users accessing the network addressable content data set, corresponding to a node. In this embodiment, the traffic type contextual metadata includes (when available) the following sub-types of traffic type contextual metadata: (i) traffic level of the network addressable content data set in the last year; (ii) traffic level of the network addressable content data set in the last five (5) years; (iii) repeat viewers of the network addressable content data set; (iv) number of viewers that have a low education level; and (iv) number of comments (including, “likes,” “dislikes,” and the like) left for the article at its website (or at another network addressable site). In this embodiment, the content of comments themselves are included as “content” of a node, rather than as “contextual metadata” of a node. However, some embodiments may store the text and/or images of the comments, themselves, as a sub-type of traffic type contextual metadata. To the extent possible and/or available, in this embodiment, sub-sub-mod 314 collects this information automatically over the network(s) used to retrieve the content data sets using queries controlled by machine logic based rules in sub-sub-mod 314.

For example, in the embodiment under discussion, the nodes that have a very low traffic level in the last five years, but a relatively large proportion of repeat viewers in the past five years are nodes: A2, B2, C2 and F3.

Processing proceeds to operation S275, where make connections mod 315 makes connections between the nodes of story data graph 500 based upon machine logic rules which use, as at least part of their respective inputs, contextual metadata of the nodes A1 to F3. More specifically, for each connection between a pair of nodes determined by mod 315: (i) a corresponding connection data set 502, 504 . . . 598 is stored in story data graph data set 500 of graph data store 240 (see FIG. 1B); (ii) the nodes involved in the pairwise connection are stored in a data sub-set of the corresponding connection data set (see FIG. 1B at nodes involved block 502a); (iii) a “connection strength” of the connection is stored in a connection strength data sub-set of the corresponding connection data set (see FIG. 1B at connection strength block 502b); and (iv) a directionality of the connection is stored in a connection directionality data sub-set of the corresponding connection data set (see FIG. 1B at connection directionality block 502c).

This somewhat simplified example includes only four (4) such machine logic rules to make connections for clarity of explanation purposes. Some embodiments of the present invention may include a large multiplicity of such machine logic based rules in order to selectively make a large multiplicity of connections between the nodes (and, it should be kept in mind that some embodiments may also be compounded in complexity in the sense that their story data graphs will include a large multiplicity of nodes, unlike the present example which has but eighteen (18) nodes). The four machine logic based rules of the present example will be respectively discussed in the following four (4) paragraphs with reference to FIGS. 4B to 4E.

FIRST RULE: For any two nodes that do not have any geo-related contextual metadata in common. The idea here is that the story should have universal appeal across the various geographical regions of the world. Therefore, in this particular example, it is desired to avoid automated stories that draw only upon seed materials from a single, common geographical region. This “first rule” tends to lead to making many connections to a node that is geographically different than the other nodes in the story data graph. In the present example, this leads to the connection pattern shown in story data graph 500b (that is, a version of the story data graph that shows only connections based upon the “first rule) of FIG. 4B. In this example, mod 315 determines that: (i) most nodes have “United States of America” as contextual metadata for a location of the owner (network storage type contextual metadata), location of the server (network storage type contextual metadata), birth place of the author(s) (content type contextual metadata) and/or location of copyright (content type contextual metadata); (ii) any two nodes that have United States of America in the contextual metadata are not connected under the first rule; (iii) node F3 does not have United States of America in any of its contextual metadata (rather, it has “India” in any and all contextual metadata fields relating to geographical region); (iv) as mentioned above, node C2 does include “India” in its contextual metadata (as birthplace of the author); and (v) based on the foregoing, the application of the first rule results in connections between node F3 and every other node except C2. Again, this is shown in FIG. 4B. In this example, each of these connections, under the machine logic based first rule assigns a connection weight of 1.0 to the connection—this will become important later on during the operation of determining “aggregate connection strength.” In this example, all connections are bi-direction, meaning that the connection is considered applicable toward the connection of both of the pair of nodes involved in a given connection.

SECOND RULE: Any two nodes will be connected with a bi-directional connection if they have: (i) low traffic in the last five (5) years (traffic type contextual metadata; and (ii) a relatively large proportion of repeat viewers in the past five years. The idea here is that the story should not contain too much subject matter that a reader has seen before (that is, exclude high traffic nodes from second rule type connections), but the content should be appealing, meaning that repeat viewers is a positive attribute. Mod 315 determines the nodes meeting the conditions of the second rule are as follows: A2, B2, C2 and F3. These connections are shown at story data graph 500c of FIG. 4C. These connections are each accorded a connection strength of 2.0.

THIRD RULE: Any two nodes that have common first or second generation backlinks, or frontlinks, will be connected by a bi-directional connection, and the connection will be accorded a connection strength of 5.0. In this example, mod 315 determines that nodes D2 and E2 have a common second generation frontlink website in their linkage type metadata. This third rule connection is shown at story data graph 500d of FIG. 4D.

FOURTH RULE: Any two nodes that have common theme (content type metadata) will be connected by a bi-directional connection, and the connection will be accorded a connection strength of 0.2. In this example, mod 315 determines that: (i) nodes D2 and E2 have a common theme (human versus nature); (ii) nodes E1 and E3 have a common theme (human versus society); and (iii) nodes C3 and A2 have a common theme (things that bring satisfaction and fulfillment). This fourth rule connection is shown at story data graph 500e of FIG. 4E.

Processing proceeds to operation S280 where aggregate connection strength mod 316 determines, and stores, an aggregate connection strength value for each node A1 to F3 of story data graph 500. In this example, an aggregate connection strength for a node is a sum of each connection involving the node multiplied by the respective connection strength value for the respective connection involving the node. More specifically, the aggregate connection strengths in this particular example, based on the connections and connection strength values determined at operation S275, are as follows: A1=1.0; A2=7.2; A3=1.0; B1=1.0; B2=7.0; B3=1.0; C1=1.0; C2=6.0; C3=1.2; D1=1.0; D2=6.2; D3=1.0; E1=1.2; E2=6.2; E3=1.2; F1=1.0; F2=1.0; and F3=22.0. In other embodiments, the aggregate connection strength may simply be the “rank” of the node, which means the number of connection in which a node is involved, without application of any weighting factors for any of the connections. In these embodiments where rank is used as the aggregate connection strength value, multiple connections (that is, connections based upon multiple different connection establishing machine logic based rules) between a given pair of nodes may, or may not, be used to enhance the rank value.

Processing proceeds to operation S285, where recommended node mod 318 determines the nodes with the highest aggregate connection strength values. In this example, mod 318 picks the top 50% of nodes (that is it chooses nine (9) out of the eighteen (18) total nodes) with the largest aggregate connection strength value scores, and designates these nodes as recommended candidate nodes for use in the automated story that is being written by method 250. More specifically, in this example, mod 318 determines the nine (9) recommended candidate nodes to be as follows: A2, B2, C2, C3, D2, E1, E2, E3 and F3. Alternatively, other predetermined standards may be used to select the nodes based on aggregate connection strength values. For example, alternatively, all nodes having an aggregate connection strength greater than 2.0 could be selected as the recommended candidate nodes.

Processing proceeds to operation S290, where mod 318 recommends the recommended candidate nodes to further stages of the automated story process. During these further stages, the recommended candidate nodes may be further culled to select “highly recommended candidate nodes” (for example, further culling by connectivity parity values as discussed in the next sub-section of this Detailed Description section).

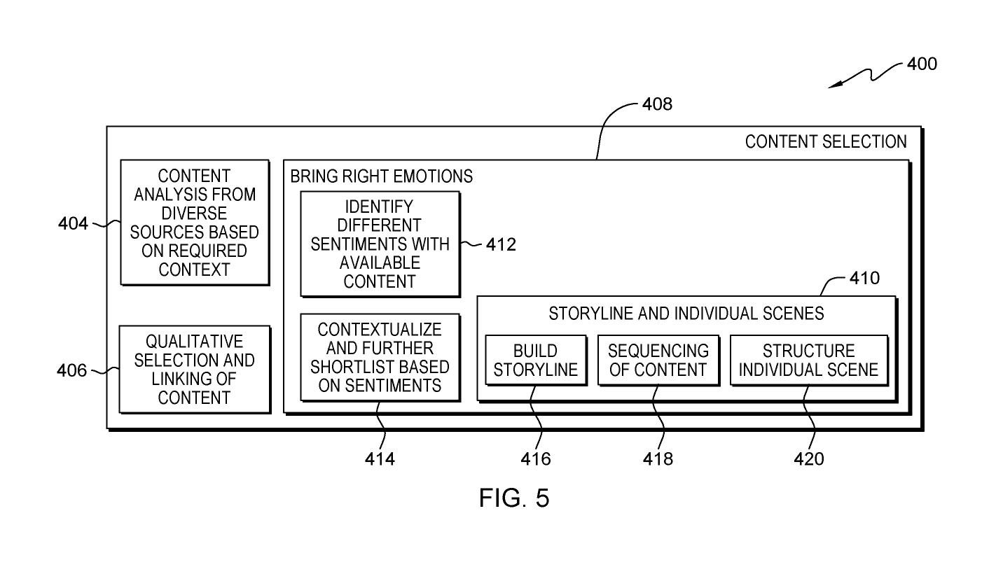

FIG. 5 shows automated story process block diagram 400 including the following blocks: 404, 406, 408, 410, 412, 414, 416, 418 and 420. In diagram 400, blocks 404 and 406 represent the part of the process performed, in this particular embodiment, by method 250, while the other blocks represent possible further stages of the automated story process.

A full discussion of possible further stages of the automated story process is outside of the scope of this document. However, an example automated story, annotated to show content derived from content data sets corresponding to the recommended candidate nodes, will now be set forth in the following paragraph(s).

ABLE AND BAKER FIND TRUE LOVE: Once upon a time, in a geo experiencing an outbreak of the Ebola virus (see node D2), Able and Baker met at an international convention of zookeepers (see node C2). Able was a zookeeper who came from far away to attend the convention in order to help him perform better in his job as a zookeeper. Baker was a data analyst who was providing data analysis services (node C3) for the zookeeper convention. During the convention, Able and Baker went on a series of dates and engaged in popular activities typical of the type of activities in which dating couples engaged in the geo of the zookeeper convention during the weeklong international meeting. While these activities seemed exotic to Able, who was from far away, Baker understood the local culture quite well and was able to keep Able at ease and comfortable. During one of these dates, the popular oldies song “Love Is A Much Enamored Thing” (node B2) was played over a public address system.

Baker exclaimed to Able, “This song expresses exactly how I have come to feel about you!”

Able leaned over towards Baker's face and whispered in Baker's ear, “I am sad that I am leaving tomorrow to return to my far away homeland to resume work as a zookeeper. However, if you would like, you can come and join me if your job as a data analyst permits.”

Baker replied, “I will have to stay in this geo for a month after the zookeeper convention to analyze all the useful data which I have been collecting at the zookeeper convention—after that, I will ride a helicopter to your home prefecture and we can try to have a sustained romantic relationship.”

Able blushed and cooed as follows: “I think that is a grand agenda, and I don't see any way that our plans could be subverted.”

The next day, Able left the geo of the zookeeper convention and returned home to tend to the flock of passenger pigeons and herd of Quaggas (node C2) which were hosted at Able's employer's zoo in Cityville (node C2). A month passed, during which Able and Baker exchanged telegrams (node C2) everyday, chatting about their expectation to be together in lovely Cityville.

Just a few days before Baker's scheduled helicopter transport to Cityville, Baker had to go get bottled water at the local supermarket because there was lead in the municipal water (node E1). Baker was quite thankful that Baker's training in math and science enabled Baker to become a data analyst (nodes C3 and E3), and, therefore, handily afford the cost of the clean, refreshing bottled water for the interval until the lead would be extirpated from the drinking water (node E1). At the local supermarket, Baker spied a broadsheet (node C2) which announced a health-related travel restrictions (node E2) because of the outbreak of the Ebola virus (node D2) in the geo where Baker resided and the zookeeper convention had been held.

Baker sent Able a telegram which read as follows: “Our burgeoning romance faces the obstacle of a natural catastrophe (nodes D2 and E2) in the form of the health-related travel restrictions occasioned by the Ebola virus. I am not permitted to leave my geo for an indeterminate, but likely lengthy, interval of time (node E2). Because of this, I must say goodbye forevermore. It is for the best, though. I certainly don't want to become a disease vector and render ill the passenger pigeons and Quaggas at the Cityville Zoo (node C2). I wipe away my tears from my cheeks and prepare to move on to a lonely life without the heat of the unquenchable fire of your talented zookeeper's spirit (node C2). I will think of you every time I analyze a datum, here in my isolated geo, and obtain useful outputs therefrom. I feel like we are involved in a conflict against society, and its problems, and that society has won (nodes E1 and E3). Still, I must always remember that the society that is keeping us apart is the same society that facilitated your attendance at the zookeeper convention, in the first place, such that my heart has become empowered to cherish precious memories of you for as long as I may maintain homeostatic balance in the organs of my body.”

The next day, Able wrote a telegram that read as follows: “O, Baker! Stay proud my Tasmanian tiger (node C2) hearted dandelion flower! We can overcome the obstacle of this natural catastrophe (nodes D2 and E2). I just read in a scientific journal on the internet that health-related travel restrictions are no longer considered as burdensome as they used to be because people can communicate using new communications networks, powered by cloud, using new services like email, chat, social networking and video VOIP (voice over internet protocol governed channels) (node E2). We can be together always in cyberspace, and, by the grace of destiny, our love will shine as bright as the combined reflective glow of a thousand Moons of the Earth, often referred to, more simply, as the Moon! You just need a smart phone with a built in camera.”

Upon receipt of the latest telegram from Able, Baker went out and purchased a smart phone, and a high capacity data plan at a terrific rate to go with it, utilizing expendable income from Baker's data analyst compensation (node C3 and E3). In due course, Able and Baker were married over the internet and lived for several decades in indescribable happiness (node F3) caused by a love based upon the sharing of mutual interests (node A2) through the communicative power of public and private clouds. Although Able's and Baker's respective bodies eventually died from old age, they were able to have their minds continue as perfect simulacra in the form of artificial intelligence entities (using the money saved over the course of Baker's data analyst career in a tax deferred retirement account), communicating over the internet from the grounding of their respective geos for 4,314,152,558 years and 224 days until the Sun exploded and the Earth ceased to exist. THE END.

### III. Further Comments and/or Embodiments

Some embodiments of the present invention recognize the following facts, potential problems and/or potential areas for improvement with respect to the current state of the art: (i) stochastic models assume that the variables are not-interdependent; (ii) game theory models expect a set number of variables, and do not have flexibility to modify the number of variables for different iterations; (iii) probability theory (a) does not account for the inter-relationships, (b) applies distribution models to singletons (a singleton is a set with exactly one element), (c) does not account for decisions to be uncertain, and/or (d) does not self-learn over iterations; (iv) weighted averages do not take into account the interrelationships and do not allow past evidence to be attached; and/or (v) multivariate analysis models do not allow for the variables to change the relationships over different iterations, and do not allow past evidence to be attached; (vi) conventional sentiment analysis tools perform sentiment analysis of a given subject but that, by itself, cannot be used to create a cohesive story.

Some embodiments of the present invention may include one, or more, of the following features, characteristics and/or advantages: (i) provides a structured approach for mining data that is available from social media, internet and other sources; (ii) putting the mined data together into a cohesive story with a desired set of emotions; (iii) provides a comprehensive analysis and mathematical model justification; (iv) can be applied to create a story for movie or a book including bringing out a cohesive story along with a desired set of emotions; (v) provides a method for generating a story itself; (vi) creates a complete story from huge range of sources with unrelated content; (vii) provides to an audience a rich experience which is mixed with desired set of emotions and messages; (viii) brings in different emotions and meaningful sequences; (ix) writes a cohesive story from a wide range of sources and which do not necessarily provide multi-media type of data; and/or (x) does not require a story script as input.

There is large number of unstructured content available on social media, sites having a subject matter focus, forums, government organization sites, and non-governmental organization (NGO) sites etc., which provide rich content for any kind of story writing. This remains highly unexplored if used manually for story writing. Some embodiments of the present invention provide a method for using content, spread across a vast array of sources, into a cohesive and appealing story.

Summaries of two operations will be respectively presented in the following two paragraphs. FIRST OPERATION: organizing content. SECOND OPERATION: rating content available from research.

In the first operation, organizing content, an author identifies the research domain. The scope sets up the context. The content is then organized under various components of the story. This operation includes the following sub-operations: (i) mining into the data sources; (ii) organizing the data into a graph; and/or (iii) defining the structure of the graph. The outputs of the first operation are as follows: (i) the structure of the graph; (ii) nodes that are available and vertex-defined linking that links available content.

In the second operation, rating content available from research, data made available from mining is rated to identify a level of quality (that is, how close or far from optimal) in the research achieved. The operation includes the following sub-operations: (i) determine metrics relative to the graph; and/or (ii) determine the quality of data that has been mined based on the metrics. The outputs of the second operation are as follows: (i) rank of the graph; (ii) incidence of the graph; and/or (iii) shortlisted content linked and ready to be used for story writing.

Some embodiments of the present invention perform the following functions: (i) graphing mined data; and/or (ii) content shortlisting and qualitative linking and ranking. These functions will be described further in the few paragraphs that follow.

1. Data Mining

Data mining (searching) is based on a context (and other parameters) defined by an author. Relevant data that is gathered in the mining phase is organized into a graph such that: (i) content is represented by nodes; and (ii) relationships among the nodes are represented by edges.

Articles are stored as nodes and the corresponding metadata, including backlinks and context, connects the nodes. These connections are called edges.

A graph database (graphDB) is produced. The graphDB is a repository of all the articles or research elements that have been mined as well as the connections (backlinks, other contextual data fields such as date, time, geography, site, search keywords, etc.) that an author specifies. These contextual settings are parameterized and can be changed by the author, or can be set by default (such as defaulting to “search keywords”).

The vector of a graph gives an understanding of the relevant linkages a given article (node) has with other articles (nodes) in the search results (graphDB). The degree of the graph represents how much (how strongly) a given article is linked to other articles. In other words, a higher degree graph establishes the finding that the articles are very relevant and meet maximum search criteria.

2. Content Shortlisting, Qualitative Linking and Ranking of Nodes

Concepts of “rank of a graph” and “connectivity parity” are applied to achieve content shortlisting and qualitative linking and ranking of nodes (content), such that that all related content is available to be used for story writing.

The rank of a graph is the maximum number of connections a single node can have in a simple graph (see definition in the Definitions sub-section of this Detailed Description section). The rank of a graph signifies the maximum number of linkages an article can have in a given result. The rank of a graph helps to determine the quality of the findings, given that all the findings are organized as a graph.

Connectivity parity indicates the number of distinct paths that are available between two nodes in the graph. The connectivity parity metric helps to find out the traversals available to or from a given node. Traversals indicate how many times a given node is used to move to the next node, and thus indicates the importance or relevance of the node in the search result. A node with high traversal (a pivotal node) becomes a significant spot in the graph. Traversals and rank are helpful in sequencing unstructured data. A pivotal node becomes the core construct of the subject.

Some embodiments of the present invention may include one, or more, of the following features, characteristics and/or advantages: (i) represents a revolutionary concept in story writing; (ii) writes rich and appealing stories; and/or (iii) makes use of a large number of diverse sources of publicly available content (and any other content to which author has license to access). Use cases include story writing for movies, novels, documentaries, etc.

Some embodiments of the present invention: (i) provide a strong collaborative platform for story writing of television serials; (ii) can enhance the quality and appeal of speeches given by political and organizational leaders to attempt to influence emotions of the readers in a manner similar to the way human authors traditionally try to influence the emotions of their readers; and/or (iii) enhances the feasibility of collaborative writing without current limitations.

1. Organizing Content as a Graph.

An author identifies the domain of research, which sets the scope for the context. The content is then organized under various components of the story.

A graph database (graphDB) represents related data as it inherently is: as a set of objects connected by a set of relationships, each with its own set of descriptive properties. Thus, all the content obtained (searched, mined) from public databases are organized into a graph for later processing.

All the content which is available is defined as a graph G, such that,

G=(N,E,ö) Eq. (1)

Where:
N is a finite set, called the vertices of G,
E is a finite set, called the edges of G, and
ö is a function with domain E and codomain P2(V).

Let G be a graph with n vertices, e edges and no self-loops.

All the content that has been curated from the mining is stored as a graph. The articles (content) are stored as nodes and the metadata, backlinks, context, etc. connects the nodes. These connections are called edges. GraphDB is conceptualized as a repository of all the articles or research elements that have been mined and they are connected by the backlinks or any other contextual (date, time, geography, site, search keywords) field that the author specifies. These contextual settings are parameterized and can be changed by the author.

In some embodiments of the present invention, an example graph G includes the following nodes returned by a search on the phrase “Women_Leadership”:
Women Leadership challenges
Top Women Leaders with inspiring career story
How to succeed as Women Leader
many more

A vertex-edge incidence matrix is generated. The vertex-edge incidence matrix is of order n×e and denoted by A(G)=[aᵢⱼ], whose n rows correspond to the n vertices and the e columns correspond to the e edges as follows:

$${a}_{ij} = \{ \begin{matrix}1 & if the {j}^{th} edge of {e}_{i} is incident on the {i}^{th} vertex of {v}_{i} \\ 0 & otherwise\end{matrix} \qquad Eq . ( 2 )$$

Thus, A(G) with m vertices and n edges can be represented as follows:

$$A ( G ) = [ \begin{matrix}{a}_{11} & {a}_{12} & {a}_{13} & … & {a}_{1 n} \\ {a}_{21} & {a}_{22} & {a}_{23} & … & {a}_{2 n} \\ & & … & & \\ {a}_{m 1} & {a}_{m 2} & {a}_{m 3} & … & {a}_{mn}\end{matrix} ] \qquad Eq . ( 3 )$$

Let the vector in each row is called A₁, A₂ . . . Aₘ respectively, then,

$$A ( G ) = [ \begin{matrix}{A}_{1} \\ {A}_{2} \\ … \\ {A}_{m}\end{matrix} ] \qquad E . q . ( 4 )$$

The vector of a graph gives an understanding of the relevant linkages a given article (node) has with other articles (nodes) in the search results (graphDB)

For example, how “Women Leadership Challenges” is linked to all the other articles:

The degree of the graph is represented as Δ(G) as the maximum degree for any vertex and δ(G) as the minimum degree of any vertex.

The degree of the graph represents how much (how strongly) the given article is linked to other articles. In other words, a higher degree of graph indicates that the articles are very relevant and meet maximum search criteria.

2. Rating the Graph to Define Quality of the Content

The author mines the data available and rates it to identify how optimal the data is.

Deriving Rank of the Graph:

The rank of an undirected graph is defined as the number n−c, where n is the number of vertices and c is the number of connected components of the graph. From Eq. (4), minimum rank is computed as:

Rank of A(G)=m−1 Eq. (5)

The rank of the graph is the maximum number of connections a single node can have in a simple graph (see definition in the Definitions sub-section of this Detailed Description section). This signifies maximum linkages can an article have in a given result. This parameter helps to determine the quality of the findings, given that all the findings have been organized as a graph.

Deriving Connectivity Parity:

Another way of representing the graph is by creating an adjacency matrix such that, a graph G with n vertices and no parallel edges is an n×n matrix J=[Jᵢⱼ] whose elements are given by

$${a}_{ij} = \{ \begin{matrix}1 & if the re is an edge between the {i}^{th} and {j}^{th} vertices \\ 0 & if there is no edge between them\end{matrix} \qquad E . q . ( 6 )$$

For J, aₙ(i,j) gives the number of paths of the length n from vᵢ to vⱼ (that is, the number of different edge sequences of n edges) whenever i≠j.

Suppose vᵢ and vⱼ are two nodes of graph G and J is the adjacency matrix. If matrix Bₙ is defined as:

Bₙ=J+J²+J³+ . . . +Jⁿ Eq. (7)

Then, from the matrix Bₙ we can determine the number of paths of length n or less from vᵢ to vⱼ (for i≠j).

Thus, for J, the adjacency matrix of G, from Eq. (7), connectivity parity B, is defined as,

B=J+J²+J³+ . . . +J^{m-}1 Eq. (8)

G is a connected graph if and only if for every pair of distinct indices i and j, bᵢⱼ≠0, that is, B has no zero entries.

The connectivity parity indicates the number of distinct paths that are available that connect two nodes in the graph. A purpose of this metric is to determine the traversals that are available to or from a given node. Traversals indicate how many times a given node is used to move to the next node, thus indicating the importance or relevance of the node in the search result. A node with high traversal becomes a significant node in the graph.

Deriving Quality Index:

Based on Eq. (5) and Eq. (8), the quality index Q is derived as follows:

$${a}_{ij} = \{ \begin{matrix}1 & if the re is an edge between the {i}^{th} and {j}^{th} vertices \\ 0 & if there is no edge between them\end{matrix} \qquad Eq . ( 9 )$$

Q close to 0 indicates poor quality data.

A graph of high connections will have B close to m−1 and represents a graph that is well connected, with articles that are relevant to each other. It gives the author freedom to move from one article to another as all the nodes are relevant.

Some embodiments of the present invention may include one, or more, of the following features, characteristics and/or advantages: (i) identifies most relevant content for a story; (ii) uses concepts of ranking, parity and distinct paths to help shortlist content which is a best fit; (iii) enables getting “most relevant” content from diverse sources; (vi) helps to ensure no compromise on storyline (because if identified content is not shortlisted, further mining is performed to find additional content); and (v) nodes are defined based on information that is being searched by the model, and by evaluating the ranks of respective nodes, determine which nodes are relevant to the author and which nodes are not.

In some embodiments of the present invention, data sources are mined for content, based on a context defined by an author. Relevant content (articles) that is found is organized into a graph such that articles are represented by nodes, and relationships among the articles are represented by edges between the respective nodes. Types of relationships between articles include similarities or commonalities of the articles' associated metadata, backlinks and context, for example. A graph database (graphDB) is generated which is a repository that includes all the articles or research elements that have been mined. The articles and research elements are connected (have relationships) based on the backlinks or any other contextual fields (such as date, time, geography, site, search keywords, etc.) that the author specifies. These contextual settings are parameterized and can be changed by the author. The vector of the graph gives an understanding of the relevant linkages a given article (node) has with other articles (nodes) in the search results (graphDB). The degree of the graph represents how strongly a given article is linked to other articles. In other words, a higher degree of the graph indicates articles are very relevant and closely meet the search criteria.

In some embodiments of the present invention, content shortlisting and qualitative linking and ranking of nodes (content) are performed, such that all related content is available to be used for story writing. Concepts of ranking of graph and connectivity parity are applied to achieve this objective.

Connectivity parity is the number of distinct paths that connect two given nodes in the graph. This metric determines the number of traversals that are available to and from a given node. Traversals indicate the number of times a given node is used to move to the next node, thereby indicating the importance or relevance of the node in the search result. A node with high traversal becomes a significant (or pivotal) node in the graph and becomes a core construct of the subject. Sequencing unstructured data is based on both traversals and rank.

Some embodiments of the present invention continue to go back and search unlimited content until the most relevant content with high quality has been identified and added to the graph. The degree of graph parameter helps in sequencing elements of a story and determining whether “good” content has been collected for a story, or the context-based search should be extended. Some embodiments organize all the information on the context that is pertinent to the author for a specific project. Further, the degree of graph based on context also helps to ensure selection of quality content which can also be cohesively put into a story. Some embodiments use a construct of shortlisting the content and discarding content which is not shortlisted.

Some embodiments of the present invention use a decision model, to qualify whether content is good or whether the search should be extended to find content that makes the storyline more intensive. Operations performed by the decision model include: (i) searching for information based on the author's specifications; (ii) defining the nodes of the graph based on information found; (iii) determining the rank of the graph; and/or (iv) deciding what is relevant to the author (and what is not).

In some embodiments of the present invention, articles that are stored at the nodes are continuously identified and checked against context provided by the author. Articles in context that have relevant backlinks and/or edges are reflective of the rank of the graph. Only the relevant content is retained for the author.

Some embodiments of the present invention find and filter a large volume of content, spread across different locations and repositories (for example, on the internet). Content, which is determined to be best fit (closely meets the specifications of the author) is shortlisted (retained), based on concepts of ranking, parity and distinct paths.

Some embodiments of the present invention organize all the found information into a graph. The graph can be traversed based on the objective context provided by the author. Only articles at the nodes that have the most relevant linkages are retained. The remainder of the articles are continuously purged from the database (and the graph).

Some embodiments of the present invention scan the internet for the objective context provided by the author. Once the found content is put into nodes of the graph, filtering the content to retain only relevant articles, based on the number of traversals and rank of the graph.

Some embodiments of the present invention identify content that is most relevant for a story, and use the concepts of ranking, parity and distinct paths to help shortlist the content which best fits the author's specifications and filter out other content.

Some embodiments of the present invention may include one, or more, of the following features, characteristics and/or advantages: (i) creates a graph of different information sources as nodes on a given topic or context that is specified; (ii) edges between the nodes describe the relationships, with reference to the context, so that different aspects of creating a story for the entertainment industry can be catered to; and/or (iii) addresses linkages with reference to a context.

Some embodiments of the present invention may include one, or more, of the following features, characteristics and/or advantages: (i) mines into data sources based on context defined by an author; (ii) organizes relevant data into a graph such that content is represented by nodes and their relationships are represented by edges; (iii) articles are stored as nodes and the metadata, including backlinks and context information, connects the nodes (these connections are referred to as edges); and (iv) produces a graph database (graphDB) as a repository of all the articles or research elements that have been mined as well as the connections (backlinks, other contextual data fields such as date, time, geography, site, search keywords, etc.) that an author specifies. These contextual settings are parameterized and can be changed by the author, or can be set by default (such as defaulting to “search keywords”).

The vector of a graph gives an understanding of the relevant linkages a given article (node) has with other articles (nodes) in the search results (graphDB). The degree of the graph represents how much (how strongly) a given article is linked to other articles. In other words, a higher degree graph establishes the finding that the articles are very relevant and meet maximum search criteria.

Some embodiments of the present invention apply the concept of ranking of graph and connectivity parity to achieve the objectives of: (i) content shortlisting; and (ii) qualitative linking and ranking of nodes (content) such that all related content is available to be used for story writing.

The rank of a graph is the maximum number of connections a single node can have in a simple graph. This signifies maximum number of linkages an article can have in a given result. The ranking parameter helps to determine the quality of the findings, given that all findings have been organized as a graph. Both the traversals and rank are useful in organizing unstructured data.

Some embodiments of the present invention may include a method and framework with one, or more, of the following features, characteristics and/or advantages: (i) represents a revolutionary concept in story writing; (ii) writes rich and appealing stories; and/or (iii) makes use of a large number of diverse sources of publicly available content (and any other content to which author has license to access). Use cases include story writing for movies, novels, documentaries, etc.

Some embodiments of the present invention: (i) provide a strong collaborative platform for story writing of television serials; (ii) can enhance the quality and appeal of speeches given by political and organizational leaders to attempt to influence emotions of the readers in a manner similar to the way human authors traditionally try to influence the emotions of their readers; and/or (iii) enhances the feasibility of collaborative writing without current limitations.

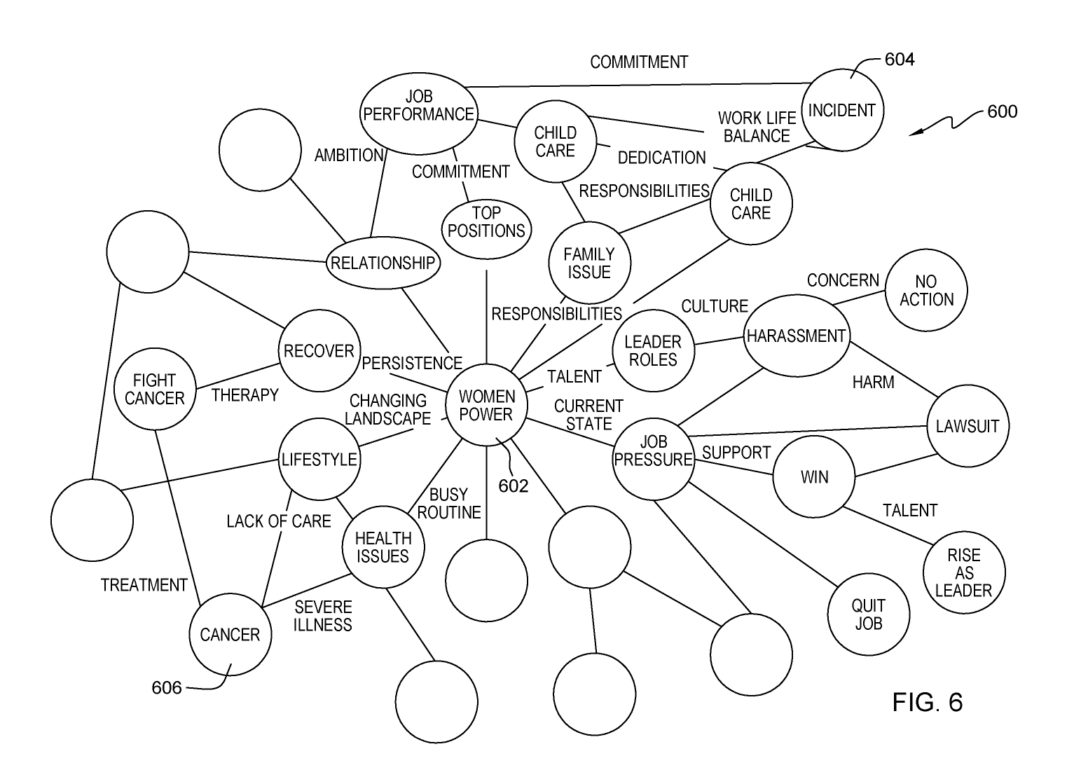

An example embodiment of the present invention will now be discussed with reference to graph 600 of FIG. 6. Graph 600 is generated by an example embodiment of the present invention. The graph represents a set of most relevant content, which is shortlisted based on content, and further refined. In other words, an output of embodiments of the present invention includes shortlisted content that is highly relevant to a given topic, the content being closely related by an author-defined context. Nodes represent content mined from different sources (for example, internet sources). Edges represent linkages between different nodes (and therefore, different pieces of content). Rank is the maximum number of connections to any node of the graph (in graph 600 for example, women power node 602 has 11 connections, more than any other node of the graph, therefore the rank of graph 600 is 11). Parity is the length of connections between two nodes.

Some embodiments of the present invention may include one, or more, of the following features, characteristics and/or advantages: (i) provides a solution that mines into data from a large number of diverse sources of data, and identifies content suitable for a given topic and context defined by an author; (ii) establishes linkages between different pieces of content based on contextual attributes; (iii) ranks content based on relevance to the given topic; (iv) prepares shortlisted content that is ready to be used for story writing; and/or (v) organizes content in graph format.

Graph 600 shows an example graph generated by an example embodiment of the present invention, including nodes that represent associated content as described in the following few paragraphs.

Women power node 602—highly rated content which refers to an increasing trend relative to women's roles in the social and corporate worlds. This article relates how an information technology consultant, Shree, is passionate about her job and her professional advancement which is achieved in a relatively short span of time.

Incident node 604—relates an incident in which Rick, a seven-year-old boy, meets with an accident in day care. His mother plays an exceptional role during this difficult time and temporarily sacrifices her professional advancement to provide required support.

Cancer node 606—describes how strongly Shree fights against a cancer. Her fight is an exceptional case in which she recovers even after being diagnosed with an advanced stage of the disease.

In some embodiments of the present invention, the rank of a graph is calculated. Rank of a graph is the maximum number of connections a single node can have in a simple graph (see definition in the Definitions sub-section of this Detailed Description section). Rank of a graph signifies maximum number of linkages an article can have in a given result.

In some embodiments of the present invention, connectivity parity determined. Connectivity parity is the number of distinct paths that exist between two given nodes in the graph. Connectivity parity reveals the number of traversals that are available to and from a given node. Traversals quantify the importance or relevance of a node. A node with a high number of traversals will become a significant spot in the graph. In sequencing unstructured data, both the traversals and rank help to identify one or more pivotal nodes, which become the core construct of the subject.

In some embodiments of the present invention, a graph database is generated based on the data mining search results. One way, among many possible ways, to characterize the graph database is as a database table, where each record represents an individual search result (a resource). Fields of the record include an address (for example, a universal resource locator (URL)) of the item, the item content itself (or in some embodiments, information that is resolvable to a memory address at which the item content can be accessed), the search term that returned the item, and any other metadata associated with the resource. Some possible types of metadata are discussed above in the Example Embodiment sub-section of this Detailed Description section.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Without substantial human intervention: a process that occurs automatically (often by operation of machine logic, such as software) with little or no human input; some examples that involve “no substantial human intervention” include: computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: Without any Human Intervention.

Simple graph: an undirected graph in which both loops, and multiple edges between a pair of nodes, are disallowed; each edge connects an unordered pair of nodes; in a simple graph with n nodes, the degree of any node is less than or equal to n−1.

Aggregate connection strength value: a quantification of how strongly a given node in a graph is directly connected to other nodes of the graph; this connection may be based on one or more of the following factors; (i) number of connections directly involving the node (this is sometimes referred to as “rank”), and/or (ii) connection strength value attributed to the connection and used to define a relative weight given to the connection.

What is claimed is:

1. A computer-implemented method of creating an automated story, the method comprising:
receiving a plurality of content data sets with each content data set including network addressable content useful in creating narrative content for the automated story;
creating a story data graph data structure stored in a graph database, with the creation of the graph data structure including:
defining a plurality of nodes, with each node of the plurality of nodes respectively corresponding to a content data set of the plurality of content data sets, and with each node including the content data of the respectively corresponding content data set and contextual metadata of the respectively corresponding to attributes of a context of the corresponding context data set, and
defining a plurality of connections among and between the nodes based upon the contextual metadata of the nodes;
for each given node of the plurality of nodes, determining an aggregate connectedness value based upon the connections in which the given node is involved;
identifying, by a processor set, a subset of recommended candidate nodes of the plurality of nodes based, at least in part, upon the aggregate connectedness values of the nodes of the plurality of nodes; and
recommending the recommended candidate nodes of the subset of recommended candidate nodes for use in the automated story.

2. The computer-implemented method of claim 1 wherein, for each given node of the plurality of nodes, the determination of the aggregate connectedness value of the given node is based, at least in part, upon a rank value of the given node, where the rank value of the given node is a number of connections in the story data graph data structure in which the given node is involved.

3. The computer-implemented method of claim 1 wherein:
for each given connection of the story data graph data structure, the definition of the connection includes determining a connection strength of the given connection based, at least in part upon the contextual metadata of nodes involved in the given connection; and
for each given node of the plurality of nodes, the determination of the aggregate connectedness value of the given node is based, at least in part, upon connection strength values for connections in which the given node is involved.

4. The computer-implemented method of claim 1 wherein, for each given node of the story data graph data structure, the contextual metadata respectively associated with the given node includes network storage related type contextual metadata.

5. The computer-implemented method of claim 4 wherein, for each given node of the story data graph data structure, the network storage related type contextual metadata of the given node includes at least one of the following sub-types: date that the given node's respectively corresponding content data set was made addressable, geographical location associated with a domain of a network address of the given node's respectively corresponding content data set, and/or owner entity of the given node's respectively corresponding content data set.

6. The computer-implemented method of claim 1 wherein, for each given node of the story data graph data structure, the contextual metadata respectively associated with the given node includes linkage related type contextual metadata; and
the linkage related type contextual metadata includes metadata relating to backlinks.

7. The computer-implemented method of claim 1 further comprising:
for each given node of the subset of recommended candidate nodes, applying connectivity parity to determine a connectivity parity value for the given node; and
identifying a subset of highly recommended candidate nodes, with the highly recommended candidate nodes corresponding to nodes with highest connectivity parity values;
wherein the recommendation the recommended candidate nodes is limited to the highly recommended candidate nodes.

8. A computer-implemented method comprising:
receiving a graph data structure stored in a graph database, with the graph data structure including:
a plurality of nodes, and
a plurality of connections; and
for each node of the plurality of nodes, applying, by a processor set, connectivity parity to identify a subset of recommended candidate nodes, with the recommended candidate nodes corresponding to content data sets recommended for use in creating a narrative story.

9. A computer program product for creating an automated story, the computer program product comprising a computer readable storage medium having stored thereon:
first program instructions programmed to receive a plurality of content data sets with each content data set including network addressable content useful in creating narrative content for the automated story;
second program instructions programmed to create a story data graph data structure stored in a graph database, with the creation of the graph data structure including:
third program instructions programmed to define a plurality of nodes, with each node of the plurality of nodes respectively corresponding to a content data set of the plurality of content data sets, and with each node including the content data of the respectively corresponding content data set and contextual metadata of the respectively corresponding to attributes of a context of the corresponding context data set, and
fourth program instructions programmed to define a plurality of connections among and between the nodes based upon the contextual metadata of the nodes;
for each given node of the plurality of nodes, third program instructions programmed to determine an aggregate connectedness value based upon the connections in which the given node is involved;
fifth program instructions programmed to identify, by a processor set, a subset of recommended candidate nodes of the plurality of nodes based, at least in part, upon the aggregate connectedness values of the nodes of the plurality of nodes; and
sixth program instructions programmed to recommend the recommended candidate nodes of the subset of recommended candidate nodes for use in the automated story.

10. The computer program product of claim 9 wherein, for each given node of the plurality of nodes, the determination of the aggregate connectedness value of the given node is based, at least in part, upon a rank value of the given node, where the rank value of the given node is a number of connections in the story data graph data structure in which the given node is involved.

11. The computer program product of claim 9 wherein:
for each given connection of the story data graph data structure, the definition of the connection includes determining a connection strength of the given connection based, at least in part upon the contextual metadata of nodes involved in the given connection; and
for each given node of the plurality of nodes, the determination of the aggregate connectedness value of the given node is based, at least in part, upon connection strength values for connections in which the given node is involved.

12. The computer program product of claim 9 wherein, for each given node of the story data graph data structure, the contextual metadata respectively associated with the given node includes network storage related type contextual metadata.

13. The computer program product of claim 12 wherein, for each given node of the story data graph data structure, the network storage related type contextual metadata of the given node includes at least one of the following sub-types: date that the given node's respectively corresponding content data set was made addressable, geographical location associated with a domain of a network address of the given node's respectively corresponding content data set, and/or owner entity of the given node's respectively corresponding content data set.

14. The computer program product of claim 9 wherein, for each given node of the story data graph data structure, the contextual metadata respectively associated with the given node includes linkage related type contextual metadata; and
the linkage related type contextual metadata includes metadata relating to backlinks.

15. The computer program product of claim 9 further comprising:
for each given node of the subset of recommended candidate nodes, applying connectivity parity to determine a connectivity parity value for the given node; and
identifying a subset of highly recommended candidate nodes, with the highly recommended candidate nodes corresponding to nodes with highest connectivity parity values;
wherein the recommendation of the recommended candidate nodes is limited to the highly recommended candidate nodes.

16. The computer program product of claim 9 wherein:
the computer program product is a computer system; and
the product further comprises a processor(s) set structured and/or connected in data communication with the storage medium so that the processor(s) set executes computer instructions stored on the storage medium.
